(19) United States
(12) Patent Application Publication
(10) Pub. No.: US 2002/0182034 A1
(43) Pub. Date: Dec. 5, 2002

(54) Transporting pack for throttle valves, and method of removing throttle valves in an at least partially automated manner from a transporting pack

(76) Inventors: Dieter Meyer, Rotenburg (DE); Jurgen Schopp, Nentershausen (DE)

Correspondence Address: Martin A. Farber, 866 United Nations Plaza, Suite 473, New York, NY, 10017, US

(21) Appl. No.: 10/138,798

(22) Filed: May 3, 2002

(30) Foreign Application Priority Data
May 15, 2001 (DE) 101 23 506.2

(51) Int. Cl. B65G 59/00

(52) U.S. Cl. 414/27; 414/800; 414/811

(57) ABSTRACT

A transporting pack (10) for throttle valves (5), comprising a housing (14) with a base (16) and a cover (18), the throttle valves (12) having at least one bore (6, 7) and at least one spacer (40), is intended to be reusable and, at the same time, to protect the throttle valves (12) in a particularly reliable manner against damage and contamination caused by transportation. For this purpose, the base (16) of the housing (14) is connected to at least one rod (20, 22), it being possible for the throttle valves (5), in order to be arranged in the housing (14), to be pushed onto the at least one rod (20) by way of their at least one bore (24, 26).

The invention relates to a transporting pack for throttle valves, comprising a housing with a base and a cover, the throttle valves having at least one bore and at least one spacer. The invention also relates to a method of removing throttle valves in an at least partially automated manner from a transporting pack.

In order to control the quantity of fresh gas in a motor vehicle, use is usually made of throttle carriers. Throttle carriers comprise a housing with a throughflow channel and a throttle element arranged in the throughflow channel. For the through-passage of a certain quantity of fresh gas, the throttle element assumes a certain position in the throughflow channel. For this purpose, the throttle element can be activated mechanically or electronically.

The throttle element of a throttle carrier is usually a throttle valve which is fastened on a throttle-valve shaft in the throughflow channel, the throttle-valve shaft being arranged pivotably in the throughflow channel. Throttle valves, during production, are usually cut out of a block of metal at a certain oblique angle. In order to fasten the throttle valves on the respective throttle-valve shaft, the blanks then obtain a first and a second bore. Finally, the surface of the throttle valves is then treated, in particular ground and smoothed. It is only then that the throttle valves are ready for installation in a throttle carrier.

The finished throttle valves are usually stacked and then taken to the location at which they are to be installed. It is often the case that the location at which the throttle valves are produced is different from the location at which the finished throttle valves are installed in the throttle carriers. It is thus usually necessary for the throttle valves to be transported from the production location to the installation location. The throttle valves are usually transported from the production location to the installation location in Styropor packs. Since the Styropor packs are usually heavily soiled during transportation from the production location to the installation location of the throttle valves, it is usually the case that the Styropor packs are not reused. At the location at which the throttle valves are installed, the throttle valves are then usually removed manually from the Styropor pack and inserted manually into the respective throttle carrier.

In this case, the Styropor pack appears to be extremely disadvantageous since very fine particles of Styropor as well as dirt arising from the transportation in particular contaminates the throttle valves. As a result of this contamination of the throttle valves, cleaning of the latter is necessary once they have been installed in the respective throttle carrier. Micrometer-range particles are disruptive here in particular since, by the effects of dirt, they may prevent proper operation of the throttle carriers. In particular in the case of a throttle carrier being installed in a motor vehicle, contamination of the throttle valves may bring about contamination in the injection units for fuel of the respective engine and produce permanent damage there.

The object of the invention is thus to specify a transporting pack for throttle valves of the abovementioned type which is reusable and, at the same time, protects the throttle valves in a reliable manner against damage and contamination caused by transportation. The intention is also to specify a method of removing throttle valves in an at least partially automated manner from such a transporting pack.

This object is achieved according to the invention in that the base of the housing is connected to at least one rod, it being possible for the throttle valves, in order to be arranged in the housing, to be pushed onto the at least one rod by way of their at least one bore.

The invention takes as its departure point the consideration that a transporting pack which protects throttle valves in a reliable manner against damage and contamination caused by transportation and which is reusable should be sealed in a reliable manner in relation to environmental influences. For this purpose, the housing of the transporting pack should be sealable in relation to environmental influences by means of a base and of a cover. Furthermore, the housing should be capable of being cleaned following use, in order that it can be reused. The housing of the transporting pack should thus consist of resistant and cleanable material. In order, during transportation of the throttle valves, reliably to avoid damage to the throttle valves, the throttle valves, furthermore, should be capable of being arranged in a certain position in the housing. Since throttle valves usually have at least one bore, by means of which they can be fastened on the respective throttle-valve shaft, the at least one bore of each throttle valve could be capable of being utilized in order to arrange the throttle valves in the housing. For the purpose of arranging the throttle valves in an organized manner in the housing, a rod is recommended as a result of the at least one bore of each throttle valve, it being possible for the throttle valves, in order to be arranged in the housing, to be pushed onto said rod.

For the purpose of filling the housing with throttle valves or of removing the throttle valves from the housing, the base of the housing, said base being connected to the at least one rod, advantageously has a sealable opening. The opening should be sealable in order reliably to prevent environmental influences from having any effect on the transporting pack during transportation of the throttle valves. Auxiliary means can be introduced into the housing via an opening in the base of the housing and, via said means, the throttle valves can be displaced upward, or lowered downward, along the rod.

The housing is advantageously more or less cylindrical. A more or less cylindrical shape of the housing corresponds to the round shape of the throttle valves. Designing the diameter of the more or less cylindrical housing for the largest diameter of the throttle valves which are usually used may make it possible here both to transport throttle valves with the largest diameter which is usually used and to transport throttle valves with a smaller diameter. This is because throttle valves often have a first and a second bore, both the spacing between the two bores and the diameter of the two bores, in the case of throttle valves with different diameters, being more or less equal. If, then, the housing has a first and a second rod, then throttle valves with different diameters can be transported by one and the same transporting pack. In other words, the transporting pack can be used for throttle valves with the same bore spacing but different diameters.

At least the housing, the base and the cover advantageously have a smooth surface, the material used for the housing, the base and the cover being plastic. Plastic is resistant and can be adapted particularly straightforwardly to predetermined shapes and is thus a particularly suitable material. Smooth surfaces can be cleaned more easily than rough surfaces and, for the purpose of reusing the transporting pack, the plastic should thus have a smooth surface. Furthermore, plastic may be produced in transparent form, as a result of which the throttle valves can be identified particularly straightforwardly by a fitter in the factory not just on account of text or any other labeling of the transporting pack but also by sight.

The at least one rod can advantageously be fixed in the housing by means of the cover. A first fixing point of the at least one rod of the housing on the base of the housing and a second fixing point of the rod on the cover of the housing additionally ensures, in a particularly reliable manner, that the throttle valves are arranged in a certain position during transportation in the transporting pack.

The method-related object is achieved according to the invention in that, for the purpose of filling the housing, first of all the throttle valves are stacked, by way of their at least one bore, on a rod in the transporting pack, and then the throttle valves are displaced on the at least one rod, by means of a displacement unit, one after the other into an access position, and the throttle valve which is to be removed in each case is accessed at the access position by a first at least partially automated gripper. Arranging the throttle valves on at least one rod in the transporting pack organizes the throttle valves. The organized state of the throttle valves may be utilized in the case of the throttle valves being removed from the transporting pack. The arrangement of the throttle valves with their at least one bore on the at least one rod of the transporting pack here allows the throttle valves to be displaced in a specific manner out of the transporting pack. If the throttle valves are gradually displaced one after the other into a certain position, in particular an access position, then an at least partially automated gripper can access them. In order that the gripper can access the individual throttle valves successfully here, the throttle valves have spacers. In the simplest case, these spacers may be pressed spacers. The pressing of, for example, more or less circular depressions on one side of a throttle valve produces more or less circular elevations on the other side of the respective throttle valve can be produced, it being possible for the more or less circular elevations to be used as spacers.

During filling of the housing, the throttle valves are advantageously placed in position one after the other, by means of a second at least partially automated gripper, into the housing at an introduction position, the displacement unit being moved on in the downward direction by a fixed distance once each throttle valve has been inserted into the housing of the transporting pack. It is not just the operation of removing the throttle valves which can be partially automated; the operation of filling the transporting pack can also be partially automated as a result of the special design of the transporting pack. A displacement unit here ensures a well-defined introduction position of the respective throttle valve, which can then be fed in an automated manner to a throttle carrier.

The displacement unit is advantageously a spindle which can be driven by an electric motor, engages in the housing, through the sealable opening, from beneath and can be displaced parallel to the at least one rod. In order to avoid particularly high outlay for the displacement unit, it is sufficient to have a spindle which presses against the lowermost throttle valve from a preferred side, in particularly from beneath, and has sufficient force in order to be able to move the throttle valves, stacked in the respective transporting pack, from bottom to top or from top to bottom.

The advantages achieved by the invention reside, in particular, in the fact that, by virtue of the arrangement of the throttle valves with their at least one bore on the at least one rod of the transporting pack, different throttle-valve diameters can be packaged and transported in one pack. In this case, for throttle valves with two bores, two rods should be provided in the respective transporting pack. The resistant and cleanable material used for the transporting pack reliably ensures here that dirt which penetrates into the transporting pack in the case of the throttle valves being introduced or removed, can be removed from the transporting pack by cleaning, which can be carried out before a further filling operation. The resistant material reliably ensures here that the transporting packs can be reused, as a result of which it is possible to reduce the transporting costs of the throttle valves on account of disposable packaging being avoided.

An exemplary embodiment of the invention will be explained in more detail with reference to a drawing. In the figures of the latter:

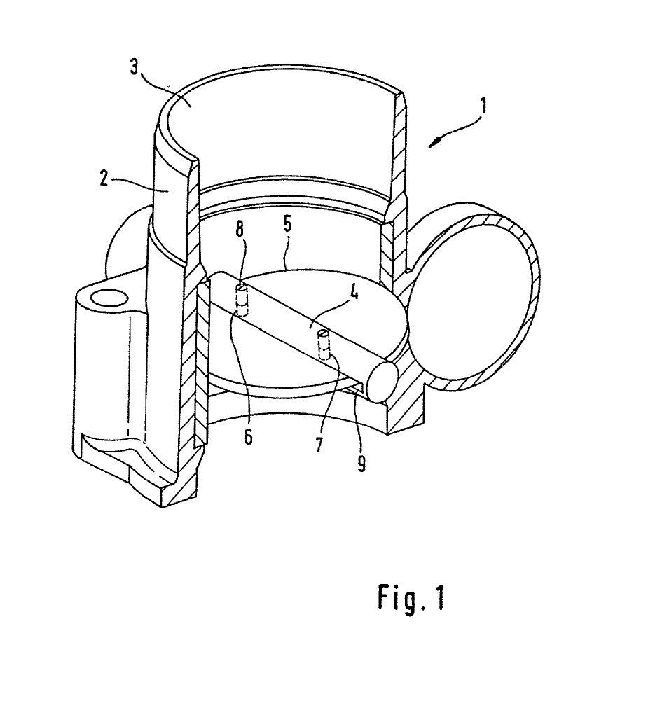

FIG. 1 shows a schematic sectional illustration of a throttle carrier,

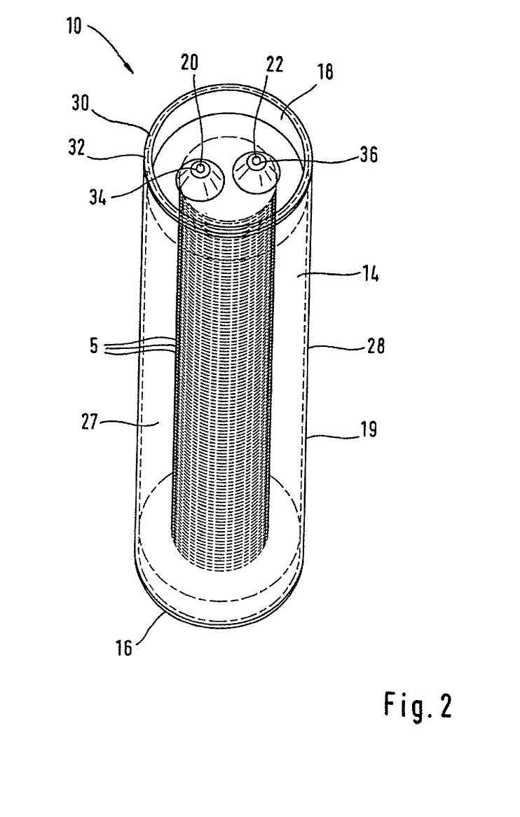

FIG. 2 shows, schematically, a transporting pack,

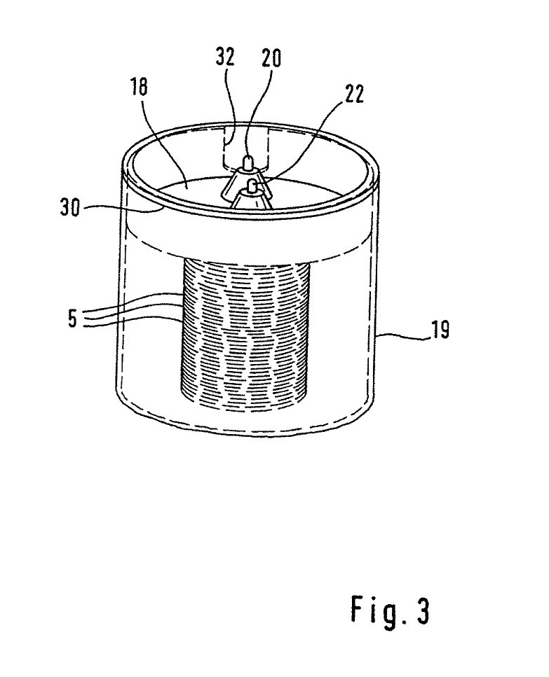

FIG. 3 shows, schematically, the top region of a transporting pack according to FIG. 2,

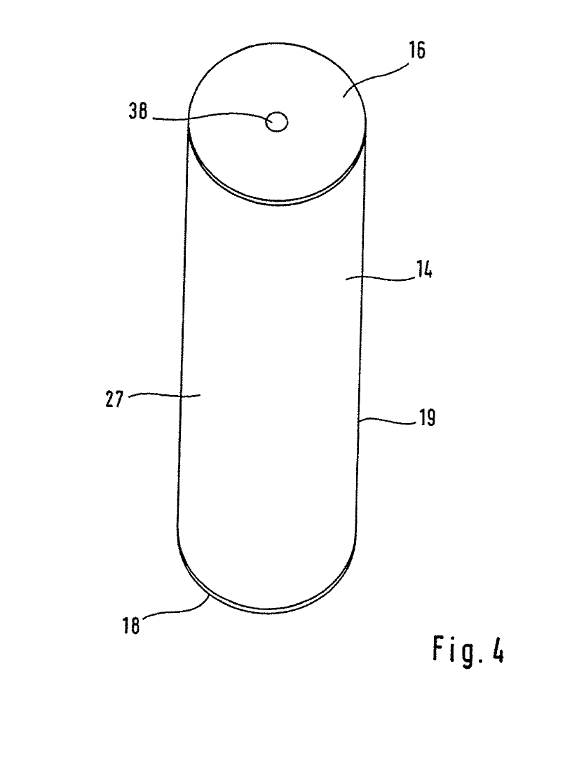

FIG. 4 shows, schematically, the bottom region of a transporting pack according to FIGS. 2 and 3,

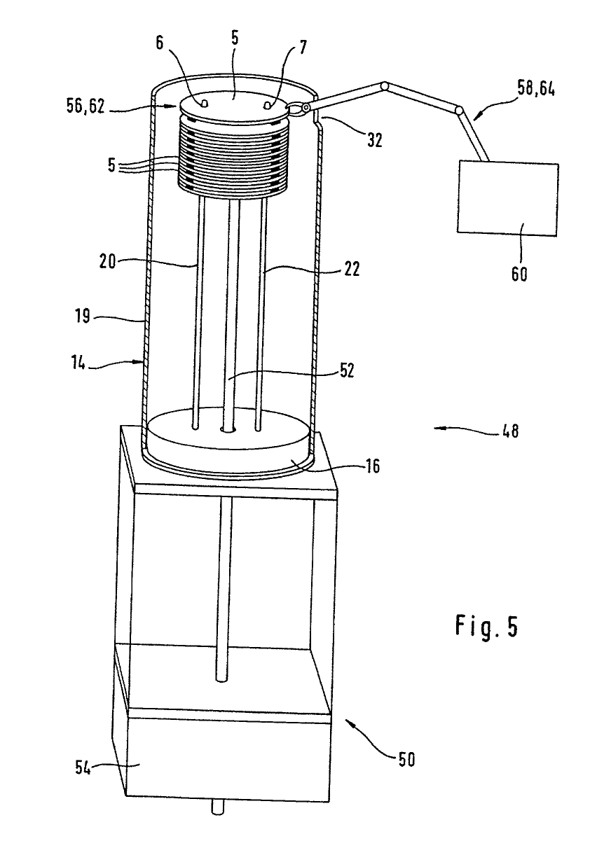

FIG. 5 shows, schematically, an apparatus for removing throttle valves from a transporting pack according to FIGS. 2 to 4.

Parts which correspond to one another are provided with the same designations in all the figures.

The throttle carrier 1 according to FIG. 1 is provided in order to feed an air or fuel/air mixture to a consuming unit, for example an injection device of a motor vehicle. In this case, the quantity of fresh gas which is to be fed to the consuming unit can be controlled by means of the throttle carrier 1. The consuming unit is not illustrated specifically in the drawing. For this purpose, the throttle carrier 1 comprises a throttle-carrier housing 2 with a continuous throttle opening 3, via which air or a fuel/air mixture can be fed to the consuming unit. In order to adjust the volume of fresh gas which is to be fed, a throttle valve 5 is arranged on a throttle-valve shaft 4 in the throttle opening 3. The throttle valve 5 here has a first bore 6 and a second bore 7, via which it is fastened in a slot 9 of the throttle-valve shaft 4 by fastening means 8, in particular screws and nuts. A rotation of the throttle valve 4 simultaneously causes the throttle valve 5, arranged on the throttle-valve shaft 4, to be pivoted, as a result of which the cross section of the throttle opening 3 is increased or reduced in size. An increase or reduction in size of the cross section of the throttle opening 3 by way of the throttle valve 5 results in regulation of the air or of the fuel/air mixture through the throttle opening 3 of the throttle carrier 1.

The throttle valves 5 provided for throttle carriers 1 are produced at a production location and then transported to a location at which the throttle valves 5 are installed in the respective throttle carrier 1. A transporting pack 10, which is illustrated schematically in FIG. 2, is provided for the purpose of transporting the throttle valves 5 from the production location to the installation location.

The transporting pack 10 for throttle valves 5 comprises a housing 14 with a base 16 and a cover 18, which are connected to one another via a housing casing 19. The base 16 of the housing 14 is connected to a first rod 20 and a second rod 22. The throttle valves 5 are arranged on the two rods 20 and 22 of the housing 14 by means of their first bore 6 and of their second bore 7. The base 16 closes the casing 19 of the housing 14 from beneath, and the cover 18 closes the casing 19 of the housing 14 from above, such that the interior 27 of the housing 14 is protected in a reliable manner against environmental influences and thus against being contaminated from the outside.

The housing 14 is more or less cylindrical. The cylinder shape is adapted to the round shape of the throttle valves 5. If throttle valves 5 with different diameters have the same spacing between their two bores 6 and 7, then it is possible for throttle valves 5 with different diameters to be arranged in the transporting pack 10 either at the same time or one after the other. In this case, the diameter of the housing 14 is such that the largest customary throttle-valve diameter still fits into the housing 14.

The base 16, the cover 18 and the casing 19 of the housing 14 are produced from resistant and cleanable material 28, which in this exemplary embodiment is in the form of plastic. Alternatively, it is also possible for the material 28 of the housing 14 to be coated wood or coated paper. Plastic can be adapted particularly straightforwardly [lacuna] predeterminable shapes and, moreover, is particularly lightweight and is thus a particularly suitable material to use for a transporting pack 10. The material 28, in the form of plastic, has a smooth surface and is thus particularly easy to clean. In addition, plastic is extremely resistant and is thus particularly suitable for a reusable transporting pack.

FIG. 3 shows, schematically, the top region of the transporting pack 10. It can clearly be seen that the housing 14 has a cutout 32 on the top border 30. With the cover 18 removed, the throttle valves 5 arranged in the transporting pack 10 can be accessed via the cutout 32. Alternatively, it is, of course, also possible for the throttle valves 5 to be inserted into the transporting pack 10 via the cutout arranged on the top border 30.

In order to accommodate the two rods 20 and 22 of the transporting pack 10, the cover 18 of the housing 14 has a first opening 34 and a second opening 36. With the cover 18 placed in position, the rod 20 then projects, out of the interior 27 of the housing 14, through the opening 34 of the cover 18, and the rod 22 projects through the opening 36 of the cover 18. The two rods 20 and 22 are fixed firmly in position in the transporting pack 10 via the openings 34 and 36. As a result, with the cover 18 positioned on the housing 14, the throttle valves 5 are fixed firmly in position in the housing 14. As a result, it is also possible to avoid additional stabilization for transporting throttle valves 5 with different diameters in the respective transporting pack 10. Fixing the two rods 20 and 22 by means of the cover 18 is usually sufficient for the purpose of transporting the throttle valves 5 correctly in the respective transporting pack 10.

FIG. 4 shows, schematically, a view of the transporting pack 10 from beneath. An opening 38 can clearly be seen in the base 16 of the housing 14. The opening 38 can be sealed by means of a plug, the plug not being illustrated specifically in the drawing.

FIG. 5 shows, schematically, an apparatus 48 for removing throttle valves 5 from the transporting pack 10. In this case, the transporting pack 10 is arranged on a displacement unit 50. A spindle 52 of the displacer unit 50 engages into the housing 14 of the transporting pack 10, through the opening 38, from beneath. On account of the opening 38 being arranged centrally in the base 16 of the housing 14, the spindle 52 of the displacement unit 50 presses centrally against the throttle valves 5. The spindle 52 of the displacement unit 50 can be moved in a linear manner by an electric motor 54. The coupling of the spindle 52 of the displacement unit 50 to the electric motor 54 is not illustrated specifically in the drawing.

In order to remove the throttle valves 5 from the transporting pack 10, then, the spindle 52 of the displacement unit 50 presses against the throttle valves 5 stacked in the transporting pack 10 until such time as the uppermost throttle valve 5 is located in a so-called access position 56. In this access position 56, an at least partially automated gripper 58 accesses the respective throttle valve 5 which is currently located in the access position 56. In this case, the at least partially automated gripper 58 engages in the housing 14 through the cutout 52 on the top border 30 of the housing 14, in order to grip the respective throttle valve 5. The at least partially automated gripper 58 can be moved here by an electric motor 60 to which it is operatively connected. By means of the partially automated gripper 58, the throttle valve 5 removed from the transporting pack 10 in each case by the gripper 58 is fed to a throttle-valve shaft 4 of a throttle carrier 1 and, once the feeding operation has taken place, the respective throttle valve 5 is fixed on the throttle-valve shaft 4 assigned to it via the bores 6 and 7 of the throttle valve 5. Alternatively, it is also possible, however, for the gripper 58 to feed the respective throttle valve 5 to a cleaning unit or a tool.

In order that the gripper 58 can grip the respective throttle valve 5 particularly straightforwardly, each throttle valve 5 has a number of spacers 61. These spacers have been produced by means of a pressing operation in which depressions have been pressed into one side of the throttle valves 5, said depressions having produced, on the other side of the throttle valves 5, elevations which can be used as spacers 61.

Alternatively, the apparatus 48 shown in FIG. 5 can also be used for filling the transporting pack 10. For this purpose, in the same way as has been described above, the transporting pack 10 is positioned on the displacement unit 50. The spindle 52 of the displacement unit is then introduced into the housing 14 and displaced until the position of the spindle 52 of the displacement unit 50 corresponds to a so-called introduction position 62. In this exemplary embodiment, the introduction position 62 corresponds to the access position 56, although, alternatively, it may also differ from the latter. In this introduction position 62 of the spindle 52, a throttle valve 5 is then automatically positioned on the rods 20 and 22 of the housing 14 by means of its bores 6 and 7. The use of a second at least partially automated gripper 64 is envisaged here, said gripper, in this exemplary embodiment, corresponding to the first at least partially automated gripper 58, although, alternatively, it may differ from the latter. Once the first throttle valve 5 has been inserted into the housing 14, the spindle 52 of the displacement unit 50 moves on in the downward direction by a fixed distance. As soon as the spindle 52 has come to rest, a further throttle valve 5 is inserted into the housing 14. The apparatus 48 is thus suitable both for filling the housing 14 with throttle valves 5 and for removing throttle valves 5 from the housing 14.

The transporting pack 10 makes it possible for the throttle valves 5 to be transported in a particularly reliable manner so as to be reliably protected against environmental influences, contamination and damage. In addition, on account of its material, the transporting pack 10 can be reused. The throttle valves 5 are reliably fixed in a certain position in the transporting pack 10 by the at least one rod 20. In addition, stacking the throttle valves on at least one of the two rods 20 and 22 makes it possible for the throttle valves 5 to be displaced along a preferred direction in the transporting pack 10, as a result of which at least partially automated removal of the throttle valves 5 from the transporting pack 10 is reliably ensured.

1. A transporting pack (10) for throttle valves (5), comprising a housing (14) with a base (16) and a cover (18), the throttle valves (5) having at least one bore (6, 7) and at least one spacer (61), characterized in that the housing (14) consists of resistant and cleanable material (28), the base (16) of the housing (14) being connected to at least one rod (20, 22), and it being possible for the throttle valves (5), in order to be arranged in the housing (14), to be pushed onto the at least one rod (20, 22) by way of their at least one bore (6, 7).

2. The transporting pack (10) for throttle valves (5) as claimed in claim 1, characterized in that, for the purpose of filling the housing (14) with throttle valves (5) or of removing the throttle valves (12) from the housing (14), the base (16) of the housing (14), said base being connected to the at least one rod (20, 22), has a sealable opening (38).

3. The transporting pack (10) for throttle valves (5) as claimed in claim 1 or 2, characterized in that the housing (14) is more or less cylindrical.

4. The transporting pack (10) for throttle valves (5) as claimed in one of claims 1 to 3, characterized in that at least the housing (14), the base (16) and the cover (18) have a smooth surface, the material (28) used for the housing (14), the base (16) and the cover (18) being plastic.

5. The transporting pack (10) for throttle valves (5) as claimed in one of claims 1 to 4, characterized in that the at least one rod (20, 22) can be fixed in the housing (14) by means of the cover (18) of the housing (14).

6. A method of removing throttle valves (5) in an at least partially automated manner from a transporting pack (10) as claimed in one of claims 1 to 5, characterized in that, for the purpose of filling the housing (14), first of all the throttle valves (5) are stacked, by way of their at least one bore (6, 7), on a rod (20, 22) in the transporting pack (10), and then the throttle valves (12) are displaced on the at least one rod (20, 22), by means of a displacement unit (50), one after the other into an access position (56), and the throttle valve (5) which is to be removed in each case is accessed at the access position (56) by a first partially automated gripper (58).

7. The method as claimed in claim 6, characterized in that, during filling of the housing (14), the throttle valves (5) are inserted one after the other, by means of a second at least partially automated gripper (64), into the housing (14) at an introduction position (62), the displacement unit (50) being moved on in the downward direction by a fixed distance once each throttle valve (5) has been inserted into the housing (14).

8. The method as claimed in claim 6 or 7, characterized in that the displacement unit (50) is a spindle (52) which can be driven by an electric motor (54), engages in the housing (14), through the sealable opening (38), from beneath and can be displaced parallel to the at least one rod (20, 22).
